(19) United States
(12) Patent Application Publication
(10) Pub. No.: US 2007/0220757 A1
(43) Pub. Date: Sep. 27, 2007

(54) Utility knife

(75) Inventor: Chun-Feng Ho, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Chi-Whi Industrial Inc., Taichung Hsien (TW)

(21) Appl. No.: 11/723,810

(22) Filed: Mar. 22, 2007

(30) Foreign Application Priority Data
Mar. 23, 2006 (TW) 95110113

(51) Int. Cl. B26B 3/06

(52) U.S. Cl. 30/153

(57) ABSTRACT

A utility knife includes a housing, a cutter blade magazine and a push block. The housing has an accommodation chamber, a protruding portion, and an opening for insertion of the cutter blade magazine into the accommodation chamber of the housing. The cutter blade magazine has a cutter blade chamber accommodating a number of cutter blades, a sliding slot, an outlet, a through hole for receiving the protruding portion of the housing, and a stop portion. The push block has a flexible arm, which is stopped by the stop portion of cutter blade magazine to prohibit displacement of the push block relative to the cutter blade magazine after separation of the cutter blade magazine from the housing and which is deformed by the protruding portion of the housing for allowing movement of the push block relative to the cutter blade magazine after insertion of the cutter blade magazine into the accommodation chamber of the housing.

### BACKGROUND OF THE INVENTION

1. Field of the Invention

The present invention relates to utility knifes and more particularly, to such a utility knife that allows for easy and safe installation of the cutter blade.

2. Description of the Related Art

A utility knife generally comprises a housing, a cutter holder mounted in the housing and movable forwards and backwards along a sliding track in the housing to extend the cutter blade out of the housing or to receive the cutter blade inside the housing. However, the cutter blade wears quickly with use. For ease of use, a cutter blade magazine type utility knife is developed. A cutter blade magazine type utility knife has spare cutter blades stored in a storage compartment inside the housing. When the cutter blade at the cutter holder is damaged, the user can push the cutter holder to the front side, and then use a cutter blade unloading device to remove the cutter blade from the cutter holder, and then move the cutter holder backwards into position for enabling one spare cutter blade to be forced into the cutter holder by a spring member to complete the cutter blade replacement operation.

Due to limited inside space of the housing, the storage compartment can only receive about 8 spare cutter blades. When the storage compartment is empty, the user must detach the housing and insert new spare cutter blades into the storage compartment one by one manually. This new spare cutter blade loading procedure is complicated and may cause accidental injury.

### SUMMARY OF THE INVENTION

The present invention has been accomplished under the circumstances in view. It is one object of the present invention to provide a utility knife, which allows for easy and safe loading of spare cutter blades.

To achieve this and other objects of the present invention, the utility knife comprises a housing, a cutter blade magazine and a push block. The housing has an accommodation chamber, at least one protruding portion extending from an inside wall thereof, and an opening in communication between the accommodation chamber and the space outside the housing. The cutter blade magazine -is inserted through the opening of the housing into the accommodation chamber. The cutter blade magazine has a cutter blade chamber for accommodating a predetermined number of cutter blades, a sliding slot in communication between the cutter blade chamber and the space outside the cutter blade magazine, an outlet in communication between the cutter blade chamber and the accommodation chamber of the housing, a through hole in communication between the cutter blade chamber and the accommodation chamber of the housing for receiving the at least one protruding portion of the housing, and stop portion provided on an inside wall thereof. The push block has a block body movably positioned in the cutter blade chamber of the cutter blade magazine, a control knob extending from the block body and received in the sliding slot of the cutter blade magazine, a support arm extending from the block body, at least one locating rod laterally extending from the support arm for securing a predetermined number of cutter blades, and a flexible arm extending from the block body. The flexible arm is stopped by the stop portion of the cutter blade magazine to prohibit movement of the push block relative to the cutter blade magazine when the cutter blade magazine is separated from the housing. The flexible arm is deformed by the at least one protruding portion of the housing such that the flexible arm is disengaged from the stop portion of the cutter blade magazine for allowing movement of the push block relative to the cutter blade magazine after insertion of the cutter blade magazine into the accommodation chamber of the housing.

### BRIEF DESCRIPTION OF THE DRAWINGS

FIG. 1 is a front view of a utility knife in accordance with a first embodiment of the present invention.

FIG. 2 is a top view of the utility knife in accordance with the first embodiment of the present invention.

FIG. 3 is a side view of the utility knife in accordance with the first embodiment of the present invention.

FIG. 4 is a schematic drawing showing the action of the cutter blade magazine of the utility knife in accordance with the first embodiment of the present invention.

FIG. 5 is a front view of the cutter blade magazine of the utility knife in accordance with the first embodiment of the present invention.

FIG. 6 is a front view of a utility knife in accordance with a second embodiment of the present invention.

FIG. 7 is a top view of a utility knife in accordance with the second embodiment of the present invention.

FIG. 8 is a schematic drawing of the second embodiment of the present invention, illustrating the utility knife in action.

FIG. 9 is a top view of the cutter blade magazine of the utility knife in accordance with the second embodiment of the present invention.

FIG. 10 is a top view of a utility knife in accordance with a third embodiment of the present invention.

### DETAILED DESCRIPTION OF THE INVENTION

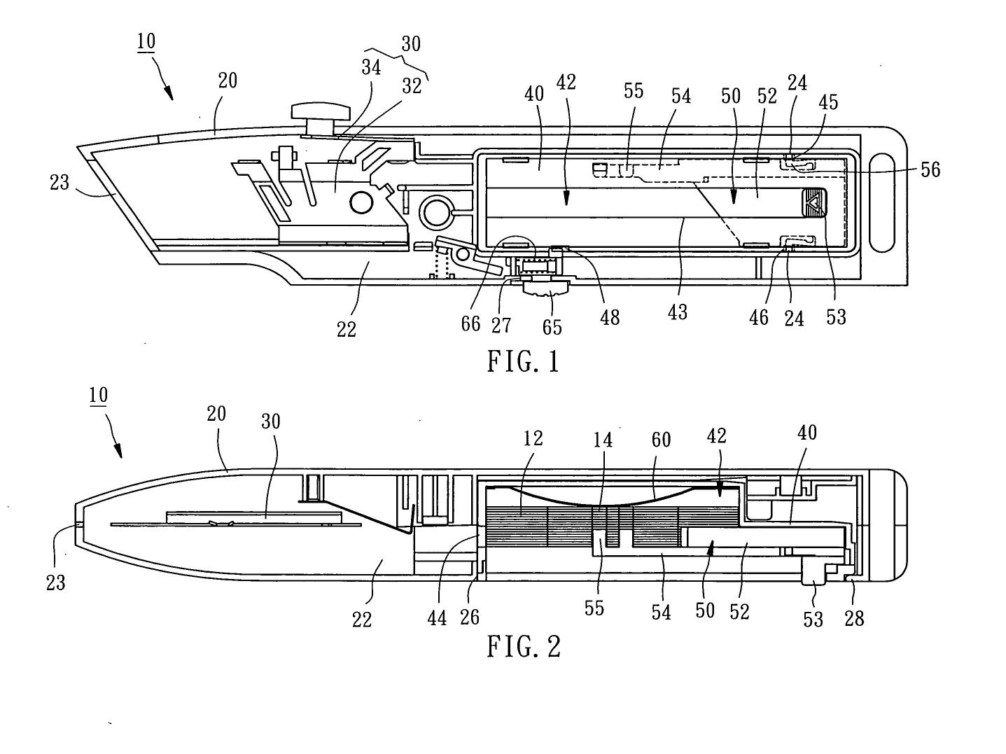

Referring to FIGS. 1˜3, a utility knife 10 in accordance with the first embodiment of the present invention is shown comprised of a housing 20, a cutter holder 30, a cutter blade magazine 40, a push block 50, a spring member 60 and a safety button 65.

The housing 20 has an accommodation chamber 22, a cutter blade outlet 23 provided on the front end of the housing 20 in communication between the accommodation chamber 22 and the outside space, two protruding portions 24 extended from the inside wall of the housing 20, an opening 26 provided on one side of the housing 20 in communication between the accommodation chamber 22 and the outside space, a short hole 27 provided on the bottom side of the housing 20 in communication between the accommodation chamber 22 and the outside space, and a stop flange 28 disposed at one end of the opening 26.

The cutter holder 30 has a holder base 32 mounted in the front part of the accommodation chamber 22 of the housing 20 for holding one cutter blade 12, and a suspension arm 34 extending from the holder base 32 to the outside of the housing 20. By means of the suspension arm 34, the user can move the cutter holder 30 forwards or backwards relative to the housing 20. When the cutter holder 30 is moved to the front side, the cutter blade 12 is extended out of the cutter blade outlet 23 of the housing 20.

The cutter blade magazine 40 is inserted through the opening 26 into the accommodation chamber 22 and secured firmly to the inside of the housing 20 by the stop flange 28 and the safety button 65. The cutter blade magazine 40 has a cutter blade chamber 42 that accommodates a certain number of cutter blades 12, a sliding slot 43 in communication between the cutter blade chamber 42 and the outside space, an outlet 44 in communication between the cutter blade chamber 42 of the cutter blade magazine 40 and the accommodation chamber 22 of the housing 20, two through holes 45 in communication between the cutter blade chamber 42 of the cutter blade magazine 40 and the accommodation chamber 22 of the housing 20 for receiving the protruding portions 24, and a stop portion 46 provided on an inside wall of the cutter blade magazine 40. In this embodiment, the stop portion 46 is formed by a periphery of each of the through holes.

The push block 50 has a block body 52 slidably supported in the cutter blade chamber 42 of the cutter blade magazine 40, a control knob 53 extending from the block body 52 and received in the sliding slot 43, a support arm 54 forwardly extending from the block body 52, two locating rods 55 laterally extending from the support arm 54 and respectively inserted into two retaining holes 14 of the cutter blades 12 that are accommodated in the cutter blade magazine 40, and two flexible arms 56 respectively extending from the top and bottom sides of the block body 52 and stopped against and deformed by the protruding portions 24 of the housing 20. By means of the aforesaid arrangement, the push block 50 can be driven to move the cutter blades 12 that are accommodated in the cutter blade magazine 40.

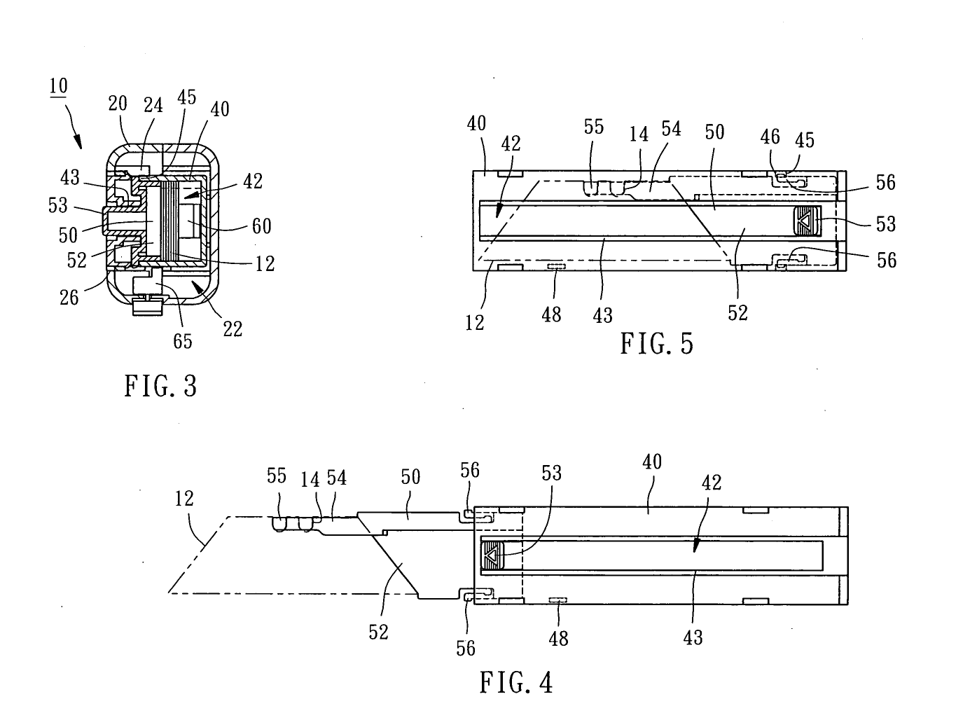

Before insertion of the cutter blade magazine 40 into the accommodation chamber 22 of the housing 20, as shown in FIG. 5, the two flexible arms 56 of the push block 50 are respectively inserted into the through holes 45 of the cutter blade magazine 40 and stopped by the stop portion 46 of the cutter blade magazine 40 such that the push block 50 is not movable relative to the cutter blade magazine 40, prohibiting accidental displacement of storage cutter blades 12 out of the cutter blade magazine 40 through the outlet 44. On the contrary, when the cutter blade magazine 40 is inserted into the accommodation chamber 22 of the housing 20, as shown in FIGS. 1 and 3, the two flexible arms 56 of the push block 50 are deformed by the two protruding portions 24 of the housing 20 such that the flexible arms 56 are disengaged from the stop portion 46 of the cutter blade magazine 40, and therefore the push block 50 is movable relative to the cutter blade magazine 40, and therefore the user can operate the control knob 53 to move the push block 50 forwards along the sliding slot 43 and to further push a predetermined number of storage cutter blades 12 out of the cutter blade chamber 42 through the outlet 44 into the front part of the accommodation chamber 22 of the housing 20 to refresh the empty accommodation chamber 22 with storage cutter blades 12, as shown in FIG. 4.

The spring member 60 is mounted in the cutter blade chamber 42 of the cutter blade magazine 40, having one end fastened to the inside wall of the cutter blade magazine 40 and the other end stopped against the storage cutter blades 12 that are stored in the cutter blade chamber 42. After the push block 50 pushed a certain number (for example, 8 pieces) of the storage cutter blades 12 out of the cutter blade magazine 40 and then returned to the inside of the cutter blade magazine 40, the spring member 60 forces the rest storage cutter blades 12 downwards into engagement with the push block 50.

The cutter blade magazine 40 is detachably fastened to the housing 20. As shown in FIGS. 1 and 2, the right side of the cutter blade magazine 40 is stopped in place by the stop flanges 28 of the housing 20. Further, the cutter blade magazine 40 has a protruding portion 48 near its left side. The safety button 65 is mounted in the accommodation chamber 22 of the housing 20 and extending to the outside of the housing 20 through the short hole 27. Further, a spring member 66 is connected between the safety button 65 and the housing 20 to bias the safety button 65 rightwards, forcing the safety button 65 to stop against the outer side of the protruding portion 48 of the cutter blade magazine 40. Therefore, the left and right sides of the cutter blade magazine 40 are positively secured to the housing 20. When wishing to remove the cutter blade magazine 40 from the housing 20, pull the safety button 65 leftward to release the protruding portion 48 of the cutter blade magazine 40 from the constraint, allowing for removal of the cutter blade magazine 40 from the housing 20.

In other words, the utility knife of the present invention uses the cutter blade magazine 40 to supply cutter blades 12. The cutter blade supplying operation is easy, and the user will not touch the cutter blades 12 during operation to prevent potential injury. Further, by means of the special structural design of the present invention, the push block 50 is not movable relative to the cutter blade magazine 40 before insertion of the cutter blade magazine 40 into the housing 20. Therefore, the invention prevents accidental displacement of storage cutter blades 12 out of the outlet 44 of the cutter blade magazine 40, i.e., the utility knife is safe in use.

Subject to the spirit and scope of the invention, the invention can be made in any of a variety of alternate forms. For example, the push block 50 can be made having only one flexible arm 56. Relatively, the housing 20 has only one protruding portion 24 and the cutter blade magazine 40 has only one through hole 45 to match the single flexible arm 56 of the push block 50.

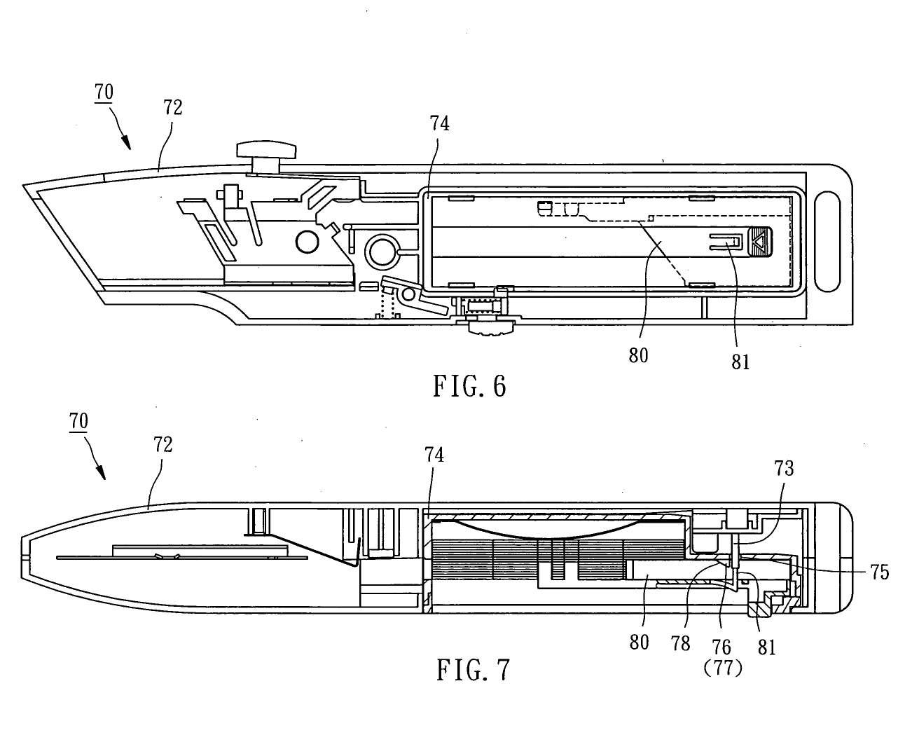

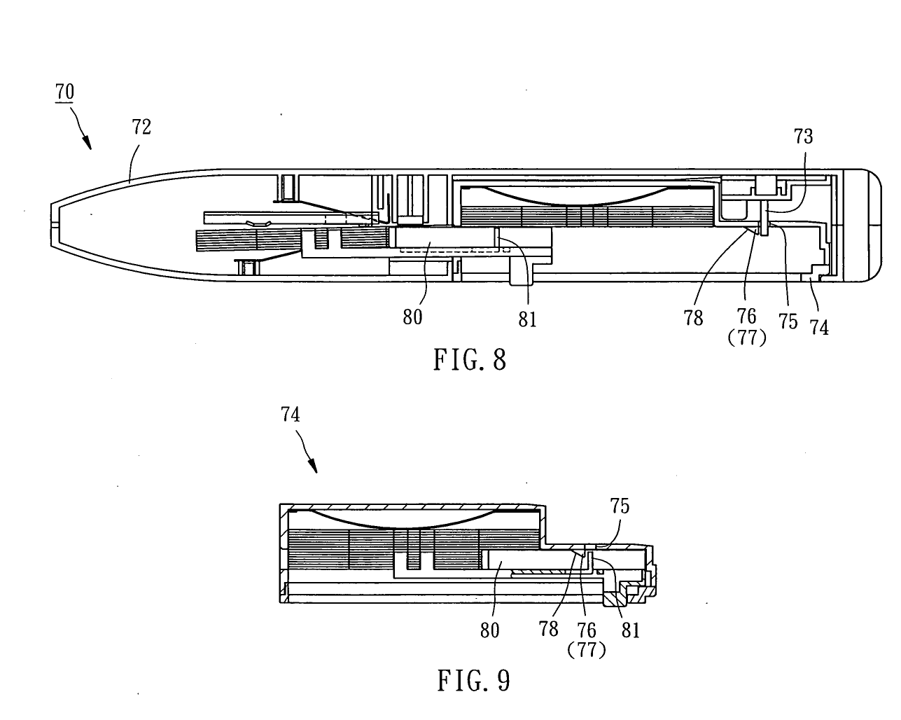

FIGS. 6 and 7 show a utility knife 70 in accordance with the second embodiment of the present invention. According to this embodiment, the housing 72 of the utility knife 70 has one protruding portion 73. The cutter blade magazine 74 has a through hole 75 and a stop portion 76. The stop portion 76 is a rib 77. The push block 80 has an L-shaped flexible arm 81. Before insertion of the cutter blade magazine 74 into the housing 72, as shown in FIG. 9, the flexible arm 81 of the push block 80 is stopped by the stop portion 76 of the cutter blade magazine 74, and therefore the push block 80 is not movable relative to the cutter blade magazine 74 at this time. On the contrary, when the cutter blade magazine 74 is inserted into the housing 72, the flexible arm 81 of the push block 80 is deformed by the protruding portion 73 of the housing 72, as shown in FIG. 7. At this time, the user can move the push block 80 to push a predetermined number of cutter blades out of the cutter blade magazine 74. To facilitate movement of the push block 80 from the position shown in FIG. 8 to the position shown in FIG. 7, the rib 77 has a beveled face 78 for guiding the flexible arm 81 of the push block 80 into position.

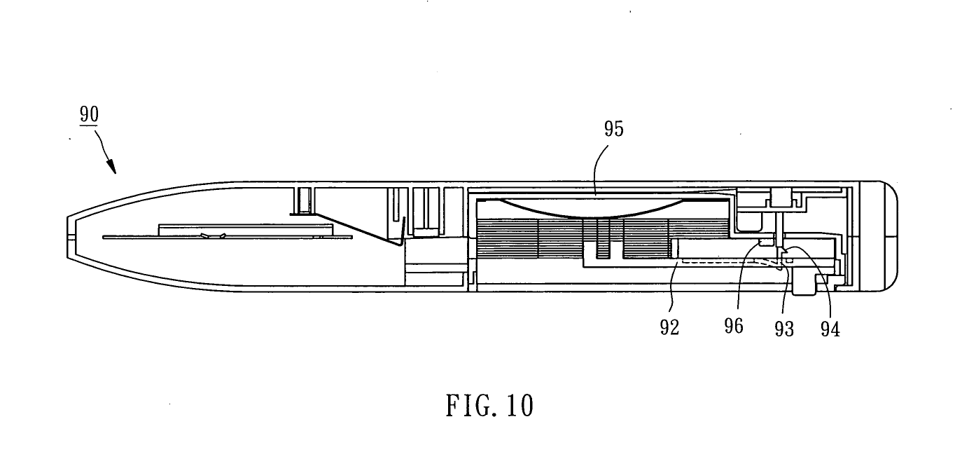

FIG. 10 shows a utility knife 90 in accordance with the third embodiment of the present invention. According to this embodiment, the flexible arm 93 of the push block 92 has a beveled face 94 on the free end to facilitate movement of the push block 92 into the position shown in FIG. 10.

A prototype of utility knife has been constructed with the features of FIGS. 1˜10. The utility knife functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims

What is claimed is:

1. A utility knife comprising:
a housing having an accommodation chamber, at least one protruding portion extending from an inside wall thereof, and an opening in communication between said accommodation chamber and the space outside said housing;
a cutter blade magazine inserted through said opening into said accommodation chamber of said housing, said cutter blade magazine having a cutter blade chamber, a sliding slot in communication between said cutter blade chamber and the space outside said cutter blade magazine, an outlet in communication between said cutter blade chamber and said accommodation chamber of said housing, a through hole in communication between said cutter blade chamber and said accommodation chamber of said housing for receiving said at least one protruding portion of said housing, and a stop portion provided on an inside wall thereof; and
a push block having a block body movably positioned in said cutter blade chamber of said cutter blade magazine, a control knob extending from said block body and received in said sliding slot of said cutter blade magazine, a support arm extending from said block body, at least one locating rod laterally extending from said support arm, and a flexible arm extending from said block body;
wherein said flexible arm is deformed by said at least one protruding portion of said housing such that said flexible arm is disengaged from said stop portion of said cutter blade magazine for allowing movement of said push block relative to said cutter blade magazine;
wherein said flexible arm is stopped by said stop portion of said cutter blade magazine to prohibit movement of said push block relative to said cutter blade magazine when said cutter blade magazine is separated from said housing.

2. The utility knife as claimed in claim 1, further comprising a spring member mounted on said inside wall of said cutter blade magazine.

3. The utility knife as claimed in claim 1, wherein said stop portion of said cutter blade magazine is formed by a periphery of said through hole.

4. The utility knife as claimed in claim 1, wherein said stop portion of said cutter blade magazine is a rib.

5. The utility knife as claimed in claim 4, wherein said rib has a beveled face.

6. The utility knife as claimed in claim 1, wherein the flexible arm of said push block has a beveled face on a rear end thereof.
